(19) United States
(12) Patent Application Publication
(10) Pub. No.: US 2006/0108570 A1
(43) Pub. Date: May 25, 2006

(54) Adjustable fulcrum member for use with a pry bar

(76) Inventor: Michael L. Del Favero, Lansing, MI (US)

Correspondence Address: Mary M. Moyne;McLEOD & MOYNE, P.C., 2190 Commons Parkway, Okemos, MI, 48864, US

(21) Appl. No.: 10/996,244

(22) Filed: Nov. 23, 2004

(51) Int. Cl. B66F 3/00

(52) U.S. Cl. 254/131

(57) ABSTRACT

An adjustable fulcrum for use with a pry bar to provide the pry bar with leverage to lift or move an object. A tool for lifting or moving an object including a pry bar with a fulcrum member. The fulcrum member has a body with slots in the sidewall of the body. The slots extend part of the length of the body of the fulcrum member between the ends of the body parallel to the longitudinal axis of the fulcrum member. One (1) end of the slots is open to allow for easily mounting the fulcrum member on the pry bar. The fulcrum member is mounted on the pry bar so that the pry bar extends through two (2) of the slots of the fulcrum member.

### CROSS-REFERENCE TO RELATED APPLICATION

Not Applicable

### STATEMENT REGARDING FEDERALLY SPONSORED RESEARCH OR DEVELOPMENT

Not Applicable

### BACKGROUND OF THE INVENTION

(1) Field of the Invention

The present invention relates to an adjustable fulcrum member for use with a pry bar. Further, the present invention relates to a lifting tool for lifting an object which includes a pry bar and a fulcrum member slidably adjustable along the length of the pry bar.

(2) Description of the Related Art

The related art shows various tools used for lifting or prying which have a fulcrum which is adjustable along the length of the bar. Illustrative are U.S. Pat. No. 4,042,210 to Feldmann; U.S. Pat. No. 3,744,758 to Nakasone and U.S. Pat. No. 3,029,502 to Middaugh.

Feldmann describes a pry tool having a fulcrum member adjustably mounted on the pry tool. The pry portion of the pry tool is slidably mounted in a slot in the fulcrum member. A clamp is provided on the fulcrum member to secure the fulcrum member to the pry portion of the tool. The fulcrum member has a substantially elliptical transverse cross-section.

Nakasone describes a fulcrum slidable along the length of a crowbar stem. The fulcrum has a ring shape with a center opening. The fulcrum has a side opening to enable the fulcrum to be slipped onto the crowbar stem.

Middaugh describes a tool for removing hub caps. The tool has a resilient fulcrum member slidably mounted on the bar. The fulcrum member has a spherical shape with an aperture extending through the center.

Also of interest is U.S. Pat. No. 2,907,106 to Lockwood which describes a hand tool for removing floor coverings. The tool has an elongated body with a fulcrum fixably mounted at one end. A blade is mounted on the fulcrum. The fulcrum has an aperture disposed on a chord of the circle so that a major portion of the fulcrum is disposed below the forward end of the body.

Also, of some interest are U.S. Pat. No. 119,770 to Ives; U.S. Pat. No. 584,189 to Nelson; U.S. Pat. No. 838,987 to Hanking and U.S. Pat. No. 949,337 to Trogner which all show staple or spike pullers having adjustable fulcrums which are slidable along the length of the puller.

Only of minimal interest is U.S. Pat. No. 2,569,242 to Kors which shows a tire lifter having a fulcrum which is fixably adjustable along a lowermost face of the bar.

There remains a need for a fulcrum member which can be adjustably and removably mounted on a pry bar and which has multiple open ended slots for enabling easy mounting of the fulcrum member on the pry bar and to allow for adjusting the leverage provided by the handle end of the pry bar.

Further, there remains a need for a lifting tool for lifting an object which includes a pry bar with an adjustable fulcrum member where the fulcrum member is movable along the pry bar to adjust the leverage provided by the pry bar and has multiple slots to allow for further adjustment of the leverage provided by the pry bar.

### SUMMARY OF THE INVENTION

An adjustable fulcrum for use with a pry bar to provide the pry bar with leverage to lift or move an object. A tool for lifting or moving an object including a pry bar with a fulcrum member. The fulcrum member has a body with slots in the sidewall of the body. The slots extend part of the length of the body of the fulcrum member between the ends of the body parallel: to the longitudinal axis of the fulcrum member. One (1) end of the slots is open to allow for ease in mounting the fulcrum member on the pry bar. In one (1) embodiment, the body of the fulcrum member is cylindrical and than three (3) slots. The sidewall of the body of the fulcrum member is curved so that the fulcrum member can easily rotate or pivot on the ground surface.

The tool is used similar to a standard pry bar. The first end of the pry bar is positioned under the object to be moved. Next, the fulcrum member is mounted on the pry bar so that the pry bar extends through two (2) slots of the fulcrum member. The handle end of the pry bar is raised up away from the ground surface and the fulcrum member is moved toward the first end of the pry bar until the fulcrum member is sandwiched between the pry bar and the ground surface and the pry bar is at the correct angle to the ground surface as necessary to provide the correct amount of leverage needed to lift the object. The leverage provided by the pry bar can be adjusted by moving the fulcrum member along the length of the pry bar between the ends of the pry bar. The leverage provided by the pry bar can also be changed by changing the slots used to mount the fulcrum member on the pry bar. Choosing slots which are spaced further apart about the circumference of the sidewall of the body of the fulcrum member increases the amount of the body of the fulcrum member located between the bottom surface of the pry bar and the ground surface which increases the angle of the pry bar with respect to the ground surface and increases the leverage provided by the handle. Once the fulcrum member is correctly positioned, a downward force is applied to the handle end of the pry bar which causes the fulcrum member to rotate and allows the pry bar to pivot about the fulcrum member lifting the first end of the pry abr away from the ground surface and thus, lifting the object.

The tool can also be used to move an object. A slide pad on the outer surface of the sidewall of the body of the fulcrum member between the two (2) of the slots is constructed of a low friction material and has a smooth outer surface. When a force is applied to the pry bar to lift the object, the slide pad contacts the ground surface. When a moving force is applied to the handle end of the pry bar, the fulcrum member slides along the ground surface on the slide pad and the force is transferred to the lifted object to move the object in the direction of the moving force.

The present invention relates to a tool for lifting an object which comprises: a pry bar having a first end and an opposed second end forming a longitudinal axis of the pry bar; and an adjustable and removable fulcrum member having a first end and a second end forming a longitudinal axis of the fulcrum member with a sidewall extending along the longitudinal axis between the ends, the fulcrum member having at least three, spaced apart slots extending parallel to the longitudinal axis of the fulcrum member, each slot having an open end adjacent the first end of the fulcrum member, wherein the fulcrum member is configured to be slidably mounted on the pry bar between the first and second ends of the pry bar so that the pry bar extends between two of the slots through the fulcrum member.

Further, the present invention relates to a tool for lifting an object which comprises: a pry bar having a first end and a second end forming a longitudinal axis of the pry bar; and a fulcrum member configured to be slidably and removably mounted on the pry bar between the ends of the pry bar, the fulcrum member having a first end and a second end forming a longitudinal axis of the fulcrum member with a sidewall extending between the ends and having at least three spaced apart slots extending parallel to the longitudinal axis of the fulcrum member, each of the slots having an open, first end adjacent the first end of the fulcrum member, wherein at least a portion of the sidewall of the fulcrum member adjacent the slots is curved and wherein the fulcrum member is mounted on the pry bar so that the pry bar extends between two of the slots of the fulcrum member with the first end of the pry bar extending beyond one of the slots of the fulcrum member in a first direction and the second end of the pry bar extending beyond one of the other slots of the fulcrum member in a second direction opposite the first direction.

Still further, the present invention relates to a fulcrum member for use on a pry bar for lifting an object away from a surface, the pry bar having a first end and a second end, the fulcrum member which comprises: a body having a first end and a second end forming a longitudinal axis of the fulcrum member with a sidewall extending therebetween; a first slot through the sidewall of the body extending parallel to the longitudinal axis of the fulcrum member; a second slot through the sidewall of the body extending parallel to the longitudinal axis of the fulcrum member, wherein the second slot is spaced apart from the first slot so that when the fulcrum member is positioned on the pry bar in a first position, the pry bar extends through the first slot, through the body and through the second slot; and a third slot through the sidewall of the body extending parallel to the longitudinal axis of the body wherein the third slot is spaced apart from the first slot so that when the fulcrum member is positioned on the pry bar in a second position, the pry bar extends through the first slot, through the body and through the third slot.

Further still, the present invention relates to a method for lifting an object in a first direction away from a surface which comprises the steps of: providing a pry bar having a first end and an opposed second end forming a longitudinal axis of the pry bar; an adjustable and removable fulcrum member having a first end and a second end forming a longitudinal axis of the fulcrum member with a sidewall extending along the axis between the ends, the fulcrum member having at least three, spaced apart slots extending parallel to the axis of the fulcrum member, each slot having an open end adjacent the first end of the fulcrum member; positioning the fulcrum member on the pry bar so that the pry bar extends through two of the slots of the fulcrum member; positioning the first end of the pry bar between the object and the surface; moving the fulcrum member along the pry bar; and applying a lifting force on the second end of the pry bar in a second direction opposite the first direction wherein the pry bar pivots at the fulcrum member and lifts the object to a raised position in the first direction.

The substance and advantages of the present invention will become increasingly apparent by reference to the following drawings and the description.

### BRIEF DESCRIPTION OF THE DRAWINGS

FIG. 1 shows the pry bar 12 having an adjustable fulcrum member 14 being used to lift an object 100.

FIG. 2 is a side view showing the pry bar 12 lifting an object 100 off a ground surface with the fulcrum member 14 in cross-section.

FIG. 3 is a partial view of line 3-3 of FIG. 2 showing the pry bar 12 positioned in the slots 18 and 20 of the fulcrum member 14.

### BRIEF DESCRIPTION OF THE PREFERRED EMBODIMENTS

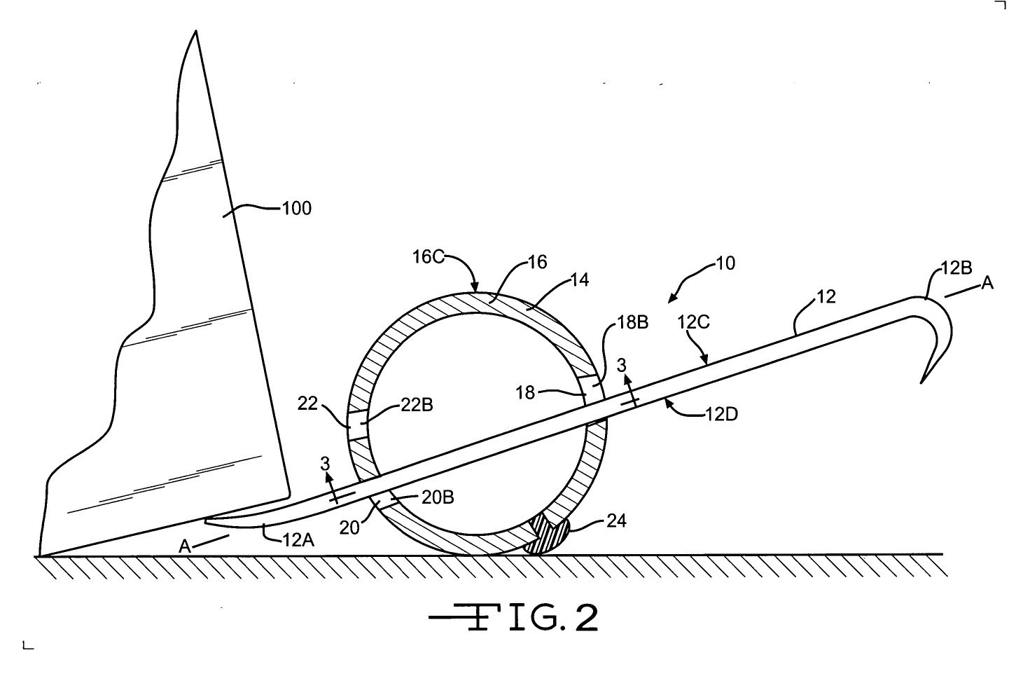

The lifting or prying tool 10 of the present invention includes a pry bar or flat bar 12 having a fulcrum member 14. The pry bar 12 has a first lifting end 12A and a second handle end 12B forming the longitudinal axis A-A of the pry bar 12 with a top surface 12C and a bottom surface 12D and sides extending along a length of the pry bar 12 between the ends 12A and 12B (FIG. 2). The first end 12A of the pry bar 12 has a wedge like shape to enable the first end 12A of the pry bar 12 to be positioned under the object 100 to be lifted. In one (1) embodiment, the second end 12B of the pry bar 12 has a hook like shape with a V-shaped notch in the end. In this embodiment, the second end 12B of the pry bar 12 can be used to remove nails or staples. In one (1) embodiment, the pry bar 12 has a rectangular shape and has an essentially flat cross-section. In another embodiment, the pry bar 12 has an essentially circular cross-section. The pry bar 12 is similar to standard pry bars or flat bars well known to one skilled in the art.

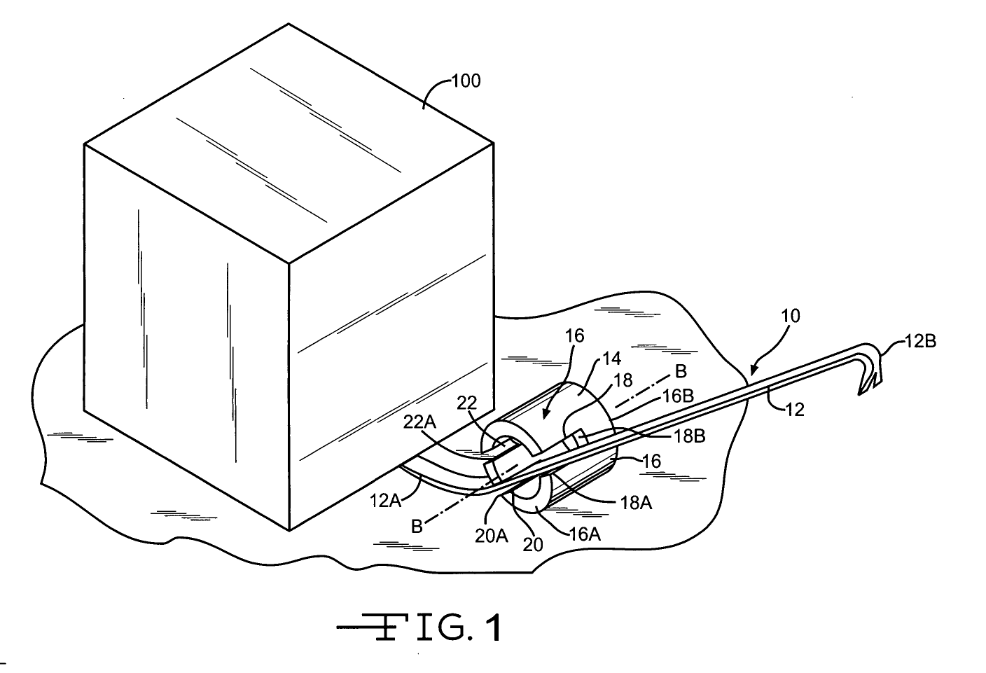

The fulcrum member 14 has a body 16 with a first end 16A and a second end 16B forming the longitudinal axis B-B of the fulcrum member 14 and having a sidewall 16C extending along a length of the body 16 between the ends 16A and 16B (FIG. 1). In one (1) embodiment, the body 16 of the fulcrum member 14 has an essentially cylindrical shape with a circular cross-section and a curved sidewall 16C. In one (1) embodiment, the body 16 of the fulcrum member 14 is hollow and the sidewall 16C surrounds a center bore. In one (1) embodiment, the body 16 of the fulcrum member 14 has a length between the ends 16A and 16B of about 2.5 inches (63.5 mm) and has a diameter of about 2.875 inches (73.02 mm). In one (1) embodiment, the length of the body 16 of the fulcrum member 14 between the ends 16A and 16B is at least equal to a width of the pry bar 12 between the sides adjacent the second end 12B of the pry bar 12.

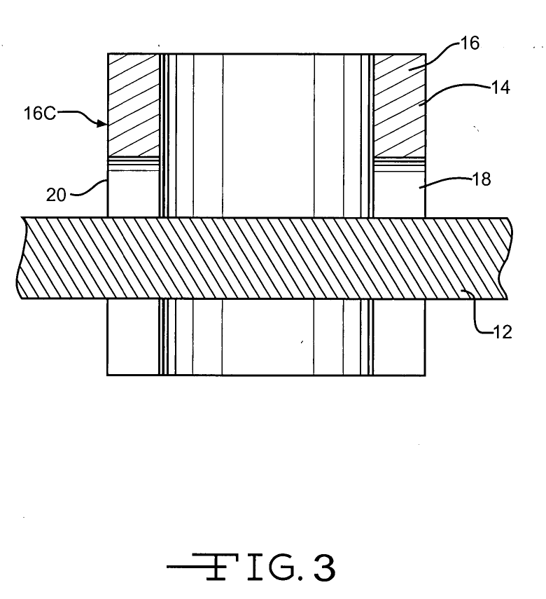

The body 16 of the fulcrum member 14 is provided with slots 18, 20 and 22 spaced apart around a circumference of the sidewall 16C of the body 16. The slots 18, 20 and 22 have opposed ends 18A, 18B, 20A, 20B and 22A and 22B defining a length of the slots 18, 20 and 22 with sides extending between the ends 18A, 18B, 20A, 20B, 22A and 22B defining a width of the slots 18, 20 and 22. The open first end 18A, 20A and 22A of the slots 18, 20 and 22 is adjacent the first end 16A of the body 16 of the fulcrum member 14. The slots 18, 20 and 22 extend from the open end 18A, 20A and 22A toward the second ends 18B, 20B and 22B of the slots 18, 20 and 22 and toward the second end 16B of the body 16 parallel to the longitudinal axis B-B of the fulcrum member 14. In one (1) embodiment, all the slots 18, 20 and 22 have a similar shape, width and length. In one (1) embodiment, the first slot 18 has a width between the sides greater than the width of the second and third slots 20 and 22. The greater width of the first slot 18 allows for moving and angling the pry bar 12 in the first slot 18 so that the pry bar 12 can be moved between the second and third slots 20 and 22 as necessary to adjust the leverage. It is understood that the size and shape of the slots 18, 20 and 22 can be adjusted depending on the size and shape of the pry bar 12 on which the fulcrum member 14 is to be mounted. In one (1) embodiment, the first slot 18 has a width between the sides of 0.5 inches (12.7 mm) and the second and third slots 20 and 22 have a width between the sides of 0.325 inches (7.94 mm). In one (1) embodiment, the width of the slots 18, 20 and 22 is such as to enable a variety of pry bars 12 having a variety of thicknesses between the top and bottom surface 12C and 12D to be used with the fulcrum member 14. In one (1) embodiment, the slots 18, 20 and 22 have a length between the ends 18A, 20A and 22A, 18B, 20B and 22B greater than a width of the pry bar 12 between the sides of the pry bar 12 so that the pry bar 12 can be positioned completely within the slots 18, 20 and 22 spaced between the ends 18A, 20A and 22A, 18B, 20B and 22B of the slots 18, 20 and 22 (FIG. 3). In one (1) embodiment, the slots 18, 20 and 22 are positioned in approximately one-half of the circumference of the sidewall 16C of the body 16. In one (1) embodiment, the fulcrum member 14 has a first slot 18, a second slot 20 and a third slot 22. In one (1) embodiment, the second and third slots 20 and 22 are spaced apart 0.5 inches (12.7 mm) about the sidewall 16C of the body 16 of the fulcrum member 14. In one (1) embodiment, the first slot 18 is spaced apart approximately 170° from the second slot 20 in a clockwise direction in the sidewall 16C of the body 16 of the fulcrum member 14. In one (1) embodiment, the first slot 18 is spaced apart approximately 170° from the third slot 22 in the counterclockwise direction (FIG. 2).

Optionally, the outer surface of the sidewall 16C of the body 16 of the fulcrum member 14 between the first and second slots 18 and 20 is provided with a slide pad 24 (FIG. 2). The slide pad 24 is positioned so that the slide pad 24 does not fully contact the ground surface until the pry bar 12 is moved into the lifting position. In one (1) embodiment, when the pry bar 12 is lifting the object 100, only the slide pad 24 on the body 16 of the fulcrum member 14 is in contact with the ground surface. The slide pad 24 has a smooth outer surface and is constructed of a low friction material so that the fulcrum member 14 can be easily moved or slid along the ground surface while the object 100 is in the lifted position (FIG. 2). In one (1) embodiment, the slide pad 24 is constructed of nylon. In one (1) embodiment, the slide pad 24 is Teflon® coated.

The lifting tool 10 is intended to be used as a pry bar or lifting bar to lift one (1) side of an object 100 away from a surface. The tool 10 can also be used to move or slide the object 100 once the object 100 is in the lifted position. The fulcrum member 14 is mounted on the pry bar 12 such that the pry bar 12 extends between two (2) of the slots 18, 20 or 22 of the body 16 of the fulcrum member 14 and through the body 16 of the fulcrum member 14 with the first end 12A of the pry bar 12 extending beyond the fulcrum member 14 in a first direction and the second end 12B of the pry bar 12 extending outward from the fulcrum member 14 in an opposed second direction. The fulcrum member 14 is mounted on the pry bar 12 so that the pry bar 12 extends through the two (2) of the slots 18, 20 or 22 of the body 16 of the fulcrum member 14 with the longitudinal axis A-A of the pry bar 12 perpendicular to the longitudinal axis B-B of the fulcrum member 14. The fulcrum member 14 is mounted onto the pry bar 12 after the lifting end 12A of the pry bar 12 is positioned under the object 100 to be lifted. The open ended slots 18, 20 and 22 of the body 16 of the fulcrum member 14 allow the fulcrum member 14 to be easily mounted onto the pry bar 12 at any point along the length of the pry bar 12.

Once the fulcrum member 14 is mounted on the pry bar 12 and the lifting end 12A of the pry bar 12 is under the object 100 to be lifted, the user adjusts the position of the fulcrum member 14 so that the length of the pry bar 12 between the fulcrum member 14 and the handle end 12B of the pry bar 12 is such that the handle end 12B has sufficient leverage to lift the object 100. The fulcrum member 14 is movable along the length or longitudinal axis A-A of the pry bar 12 to increase or decrease the leverage provided by the handle end 12B. In one (1) embodiment, the fulcrum member 14 is positioned adjacent the first lifting end 12A of the pry bar 12 to provide the handle end 12B with maximum leverage. The leverage of the handle end 12B of the pry bar 12 can also be increased or decreased by changing the slots 18, 20 and 22 used to mount the fulcrum member 14 on the pry bar 12 which changes the angle of mounting of the fulcrum member 14 on the pry bar 12. In the one (1) embodiment where the fulcrum member 14 has a first, second and third slot 18, 20 and 22, the pry bar 12 can be mounted through the first and second slots 18 and 20 to provide a first leverage or can be mounted through the first and third slots 18 and 22 to provide a second, increased leverage.

Once the fulcrum member 14 is correctly positioned on the pry bar 12, the user exerts a downward force on the handle end 12A of the pry bar 12 so that the handle end 12A moves toward the ground surface. As the handle end 12A moves toward the ground surface, the top surface 12C of the pry bar 12 contacts the top wall of the second or third slot 20 or 22 and the bottom surface 12D of the pry bar 12 contacts the bottom wall of the first slot 18 which causes the fulcrum member 14 to rotate about the longitudinal axis B-B of the fulcrum member 14. The curved or radiused outer surface of the sidewall 16C of the body 16 of the fulcrum member 14 enables the fulcrum member 14 to easily rotate or pivot on the ground surface. The pry bar 12 pivots at the fulcrum member 14 so that the lifting end 12B of the pry bar 12 is raised away from the ground surface to lift the object 100.

To move the object 100, the object 100 is lifted into a raised position using the pry bar 12 and the fulcrum member 14. Next, a moving force is applied to the handle end 12B of the pry bar 12. The moving force is applied in the direction in which the object 100 is to be moved. The moving force moves the pry bar 12 which moves the object 100. In one (1) embodiment, when the object 100 is in the raised position, the fulcrum member 14 rotates so that the slide pad 24 of the fulcrum member 14 is the only portion of the fulcrum member 14 or the pry bar 12 which contacts the ground surface. The low friction construction of the slide pad 24 along with the smooth outer surface of the slide pad 24 allows less force to be used to move the object 100 due to the minimal friction between the fulcrum member 14 and the ground surface.

It is intended that the foregoing description be only illustrative of the present invention and that the present invention be limited only by the hereinafter appended claims.

I claim:

1. A tool for lifting an object which comprises:
(a) a pry bar having a first end and an opposed second end forming a longitudinal axis of the pry bar; and
(b) an adjustable and removable fulcrum member having a first end and a second end forming a longitudinal axis of the fulcrum member with a sidewall extending along the longitudinal axis between the ends, the fulcrum member having at least three, spaced apart slots extending parallel to the longitudinal axis of the fulcrum member, each slot having an open end adjacent the first end of the fulcrum member, wherein the fulcrum member is configured to be slidably mounted on the pry bar between the first and second ends of the pry bar so that the pry bar extends between two of the slots through the fulcrum member.

2. The tool of claim 1 wherein the fulcrum member has a cylindrical shape.

3. The tool of claim 2 wherein the fulcrum member has a first slot, a second slot and a third slot and wherein a distance around a circumference of the sidewall in a clockwise direction between the first slot and the third slot is greater than a distance around the circumference of the sidewall in the clockwise direction between the first slot and the second slot.

4. The tool of claim 2 wherein the fulcrum member has a first slot, a second slot and a third slot and wherein the first slot is spaced apart around a circumference of the sidewall in a clockwise direction less than 180° from the second slot.

5. The tool of claim 1 wherein the slots have opposed ends and the pry bar has opposed sides extending between the first and second ends of the pry bar and wherein a length of each of the slots between the ends is slightly greater than a width of the pry bar between the sides.

6. The tool of claim 1 wherein the fulcrum member has three slots.

7. The tool of claim 1 wherein a slide pad is provided on an outer surface of the sidewall between two of the slots.

8. The tool of claim 1 wherein the fulcrum member is mounted on the pry bar such that the longitudinal axis of the pry bar is perpendicular to the longitudinal axis of the fulcrum member.

9. The tool of claim 1 wherein a portion of the sidewall between two of the slots is curved.

10. A tool for lifting an object which comprises:
(a) a pry bar having a first end and a second end forming a longitudinal axis of the pry bar; and
(b) a fulcrum member configured to be slidably and removably mounted on the pry bar between the ends of the pry bar, the fulcrum member having a first end and a second end forming a longitudinal axis of the fulcrum member with a sidewall extending between the ends and having at least three spaced apart slots extending parallel to the longitudinal axis of the fulcrum member, each of the slots having an open, first end adjacent the first end of the fulcrum member, wherein at least a portion of the sidewall of the fulcrum member adjacent the slots is curved and wherein the fulcrum member is mounted on the pry bar so that the pry bar extends between two of the slots of the fulcrum member with the first end of the pry bar extending beyond one of the slots of the fulcrum member in a first direction and the second end of the pry bar extending beyond one of the other slots of the fulcrum member in a second direction opposite the first direction.

11. The tool of claim 10 wherein the first and second directions are along the longitudinal axis of the pry bar and perpendicular to the longitudinal axis of the fulcrum member.

12. The tool of claim 10 wherein the fulcrum member has a cylindrical shape.

13. The tool of claim 10 wherein the fulcrum member has a first slot, a second slot and a third slot and wherein a distance around a circumference of the sidewall between the first slot and the third slot is greater than a distance around the circumference of the sidewall between the first slot and the second slot.

14. The tool of claim 13 wherein the first slot is spaced apart around the circumference of the sidewall in a clockwise direction less than 180° from the second slot.

15. The tool of claim 10 wherein a slide pad is provided on an outer surface of the sidewall of the fulcrum member between two of the slots.

16. A fulcrum member for use on a pry bar for lifting an object away from a surface, the pry bar having a first end and a second end, the fulcrum member which comprises:
(a) a body having a first end and a second end forming a longitudinal axis of the fulcrum member with a sidewall extending therebetween;
(b) a first slot through the sidewall of the body extending parallel to the longitudinal axis of the fulcrum member;
(c) a second slot through the sidewall of the body extending parallel to the longitudinal axis of the fulcrum member, wherein the second slot is spaced apart from the first slot so that when the fulcrum member is positioned on the pry bar in a first position, the pry bar extends through the first slot, through the body and through the second slot; and
(d) a third slot through the sidewall of the body extending parallel to the longitudinal axis of the body wherein the third slot is spaced apart from the first slot so that when the fulcrum member is positioned on the pry bar in a second position, the pry bar extends through the first slot, through the body and through the third slot.

17. The fulcrum member of claim 16 wherein the body has a cylindrical shape with an outer diameter of essentially 2.875 inches (73.02 cm) and wherein the second slot is spaced apart from the first slot around a circumference of the sidewall in a clockwise direction approximately 170°.

18. The fulcrum member of claim 17 wherein the third slot is spaced apart around the circumference of the sidewall in a counterclockwise direction approximately 170°.

19. The fulcrum member of claim 16 wherein a first end of the first, second and third slots are adjacent the first end of the body and wherein the first end of the first, second and third slots are open to allow access to the slots.

20. A method for lifting an object in a first direction away from a surface which comprises the steps of:
(a) providing a pry bar having a first end and an opposed second end forming a longitudinal axis of the pry bar;
(b) an adjustable and removable fulcrum member having a first end and a second end forming a longitudinal axis of the fulcrum member with a sidewall extending along the axis between the ends, the fulcrum member having at least three, spaced apart slots extending parallel to the axis of the fulcrum member, each slot having an open end adjacent the first end of the fulcrum member;
(c) positioning the fulcrum member on the pry bar so that the pry bar extends through two of the slots of the fulcrum member;
(d) positioning the first end of the pry bar between the object and the surface;
(e) moving the fulcrum member along the pry bar; and
(f) applying a lifting force on the second end of the pry bar in a second direction opposite the first direction wherein the pry bar pivots at the fulcrum member and lifts the object to a raised position in the first direction.

21. The method of claim 20 wherein in step (e), the fulcrum member is moved along the pry bar from the second end toward the first end until a length of the pry bar between the second end of the pry bar and the fulcrum member is such as in step (f), sufficient leverage is provided to enable the lifting force to lift the object.

22. The method of claim 20 wherein the fulcrum member is provided with a slide pad, wherein in step (c), the fulcrum member is positioned so that the slide pad is adjacent the surface and wherein in step (f), after the object is in the raised position, a moving force is applied to the pry bar so that the fulcrum member slides along the surface on the slide pad and the object is moved in a direction of the moving force.

23. The method of claim 20 wherein further in step (e), the fulcrum member is removed from the pry bar and repositioned on the pry bar so that the pry bar extends through at least one of the other slots so that the lifting force applied in step (f) is less.

24. The method of claim 20 wherein in step (c), the fulcrum member is positioned on the pry bar by first positioning the first end of the fulcrum member adjacent to the pry bar so that the longitudinal axis of the fulcrum member is perpendicular to the longitudinal axis of the pry bar and then moving the fulcrum member so that the pry bar enters two of the slots of the fulcrum member.

25. The method of claim 20 wherein the fulcrum member has a cylindrical shape, and wherein in step (f) during lifting of the object, the fulcrum member partially rotates about the longitudinal axis of the fulcrum member.
